(19) United States
(12) Patent Application Publication
(10) Pub. No.: US 2017/0108866 A1
(43) Pub. Date: Apr. 20, 2017

(54) METHOD AND APPARATUS FOR CONTROLLING UNMANNED AIRCRAFT

(71) Applicant: Joseph Patrick Quinn, Norfolk, MA (US)

(72) Inventor: Joseph Patrick Quinn, Norfolk, MA (US)

(21) Appl. No.: 14/711,139

(22) Filed: May 13, 2015

Related U.S. Application Data
(60) Provisional application No. 61/992,537, filed on May 13, 2014.

(51) Int. Cl. G05D 1/00; B64C 39/02

(52) U.S. Cl. CPC G05D 1/0088; G05D 1/0011; B64C 39/024; B64C 2201/146

(57) ABSTRACT

An unmanned aircraft may be configured to avoid restricted areas by storing a database defining restricted areas in a memory of the aircraft and/or in a memory of a remote controller apparatus. Processor circuitry on the unmanned aircraft and/or in the remote controller apparatus receives an input command from to maneuver the unmanned aircraft. The input command may be a control input from a pilot, or a pre-programmed flight schedule command. Before performing the commanded maneuver, the processor circuitry predicts whether the maneuver is likely to violate a flight regulation, by entering a restricted area stored in the database, for example. If a violation is predicted, the command input command is ignored, discarded and/or blocked without executing the commanded maneuver.

### CROSS REFERENCE TO RELATED APPLICATIONS

The present application claims the priority of U.S. Provisional Patent Application No. 61/992,537 entitled Method and Apparatus for Controlling Unmanned Aircraft which was filed on May 13, 2014 and which incorporated herein by reference in its entirety.

### FIELD OF THE DISCLOSURE

The present disclosure relates to unmanned aircraft and more particularly a control system for ensuring safe and legal operation of an unmanned aircraft.

### BACKGROUND

The use of unmanned aircraft, sometimes called drones and/or radio control (RC) aircraft for personal and commercial purposes continues to increase as unmanned aircraft are becoming more affordable and easier to operate. The term “unmanned aircraft,” “drone” and “RC aircraft” as used herein should be understood to have the same meaning Because operators of unmanned aircraft may be untrained or uninformed with regard to airspace regulations and safety, the use of unmanned aircraft presents a serious collision hazard to traditional manned aircraft and even to other unmanned aircraft.

In September 2013, the U.S. Department of Transportation published an Unmanned Aircraft Systems (UAS) Comprehensive Plan for addressing the integration of unmanned aircraft with the present civil airspace. It is anticipated that new laws and regulations to limit the use of unmanned aircraft may be defined and implemented. Many operators of unmanned aircraft may not be properly trained and/or informed with respect to complying with the various laws and regulations.

### SUMMARY

An aspect of the present disclosure includes a method for controlling an unmanned aircraft. According to this aspect, the method includes receiving a control signal, determining whether performing a maneuver responsive to the control signal would violate a regulation, and rejecting or ignoring the control signal in response to determining that performing the maneuver responsive to the control signal would violate the regulation.

Another aspect of the present disclosure includes a method for controlling an unmanned aircraft. According to this aspect, the method includes receiving a control input to a ground based remote control apparatus for controlling the unmanned aircraft, storing a database defining boundaries of restricted locations into a memory of the ground based remote control apparatus, determining whether performing a maneuver responsive to the control input by the unmanned aircraft would violate a regulation, automatically discarding the control input without transmitting a control signal representing the control input in response to determining that performing the maneuver responsive to the control input would violate the regulation, and automatically transmitting a control signal representing the control input to the unmanned aircraft in response to determining that performing the maneuver responsive to the control input would not violate the regulation.

According to another aspect of the present disclosure, an unmanned aircraft comprises means for receiving a control signal, means for determining whether performing a maneuver responsive to the control signal would violate a regulation, and means for rejecting or ignoring the control signal in response to determining that performing the maneuver responsive to the control signal would violate the regulation.

According to another aspect of the present disclosure, a remote control apparatus for controlling an unmanned aircraft comprises means for receiving a control input for controlling the unmanned aircraft, means for storing a database defining boundaries of restricted locations into a memory of the ground based remote control apparatus, means for determining whether performing a maneuver responsive to the control input by the unmanned aircraft would violate a regulation, means for automatically discarding the control input without transmitting a control signal representing the control input in response to determining that performing the maneuver responsive to the control input would violate the regulation, and means for automatically transmitting a control signal representing the control input to the unmanned aircraft in response to determining that performing the maneuver responsive to the control input would not violate the regulation.

An unmanned aircraft according to another aspect of the present disclosure includes receiver circuitry for receiving a control signal, memory storing a set of predetermined boundaries of restricted locations and/or storing a database of the restricted locations, processor circuitry coupled to the receiver circuitry and to the memory, the processor circuitry configured for determining whether performing a maneuver responsive to the control signal would violate a regulation, and the processor circuitry configured for rejecting or ignoring the control signal in response to determining that performing the maneuver responsive to the control signal would violate the regulation.

A remote control apparatus for controlling an unmanned aircraft according to another aspect of the present disclosure includes a user interface for receiving a control input to the remote control apparatus for controlling the unmanned aircraft, memory configured for storing a database defining boundaries of restricted locations into a memory of the ground based remote control apparatus, processor circuitry coupled to the memory and to the user interface, the processor circuitry configured for determining whether performing a maneuver responsive to the control input by the unmanned aircraft would violate a regulation, the processor circuitry configured for automatically discarding the control input without transmitting a control signal representing the control input in response to determining that performing the maneuver responsive to the control input would violate the regulation, and transmitter circuitry coupled to the processor circuitry, the processor circuitry configured for automatically transmitting a control signal representing the control input to the unmanned aircraft via the transmitter circuitry in response to determining that performing the maneuver responsive to the control input would not violate the regulation.

This has outlined the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The accompanying drawings are included to provide a further understanding of the disclosure, and are incorporated in and constitute a part of this specification. The drawings illustrate example embodiments of the present disclosure and, together with the description, serve to explain principles of the present disclosure.

FIG. 1. is a process flow diagram illustrating a method for controlling an unmanned aircraft according to an aspect of the present disclosure.

FIG. 2. is a process flow diagram illustrating a method for controlling an unmanned aircraft according to another aspect of the present disclosure.

FIG. 3 is a system block diagram illustrating an unmanned aircraft apparatus according to aspects of the present disclosure.

FIG. 4 is a system block diagram illustrating a remote control apparatus for an unmanned aircraft apparatus according to aspects of the present disclosure.

### DETAILED DESCRIPTION OF EMBODIMENTS

Embodiments of the present disclosure will now be described hereinafter with reference to the accompanying drawings. However, this disclosure should not be construed as limited to the embodiments set forth herein. Rather, these embodiments are provided so that this disclosure will be thorough and complete, and will fully convey the scope of the disclosure to those skilled in the art. Like numbers refer to like elements throughout. As used herein the term “and/or” includes any and all combinations of one or more of the associated listed items and may be abbreviated as “/”.

Laws and regulations affecting the flight of unmanned aircraft may be implemented and updated as the use of unmanned aircraft becomes more common. According to aspects of the present disclosure flight limitations proscribed by such laws and/or regulations may be represented in a memory coupled to or incorporated in a control system of the unmanned aircraft. In one embodiment, the restrictions may be a represented as a database defining boundaries of one or more types of restricted airspace, for example. The database may be updated as various regulations are implemented or as the boundaries of restricted airspace are defined and updated. A certification for legal operation of an unmanned aircraft may be conditioned on verification that a latest database of restrictions has been installed in an unmanned aircraft or in its remote control apparatus.

According to aspects of the present disclosure, a control system of the unmanned aircraft prevents accidental and/or intentional flight of the unmanned aircraft into restricted airspace. This allows safe use for many commercial purposes such as aerial photography, or inspection of rooftops, antennae and other high structures, without interfering with traditional air traffic. A processor of the control system determines whether a received command to maneuver will cause a violation of a law or regulation, by causing the aircraft to enter restricted airspace, for example. The processor determines the present location of the unmanned aircraft and predicts a future location based on the present location and on a control signal or command to maneuver the unmanned aircraft before executing the command to maneuver the unmanned aircraft. When the processor determines that executing the command will violate or has a high probability of violating a law or regulation, by entering restricted airspace as defined by a database of restrictions stored in memory, for example, the command is discarded, ignored or blocked. Thus the unmanned aircraft is effectively constrained by an invisible wall. This allows users with minimal skill levels to safely operate the unmanned aircraft.

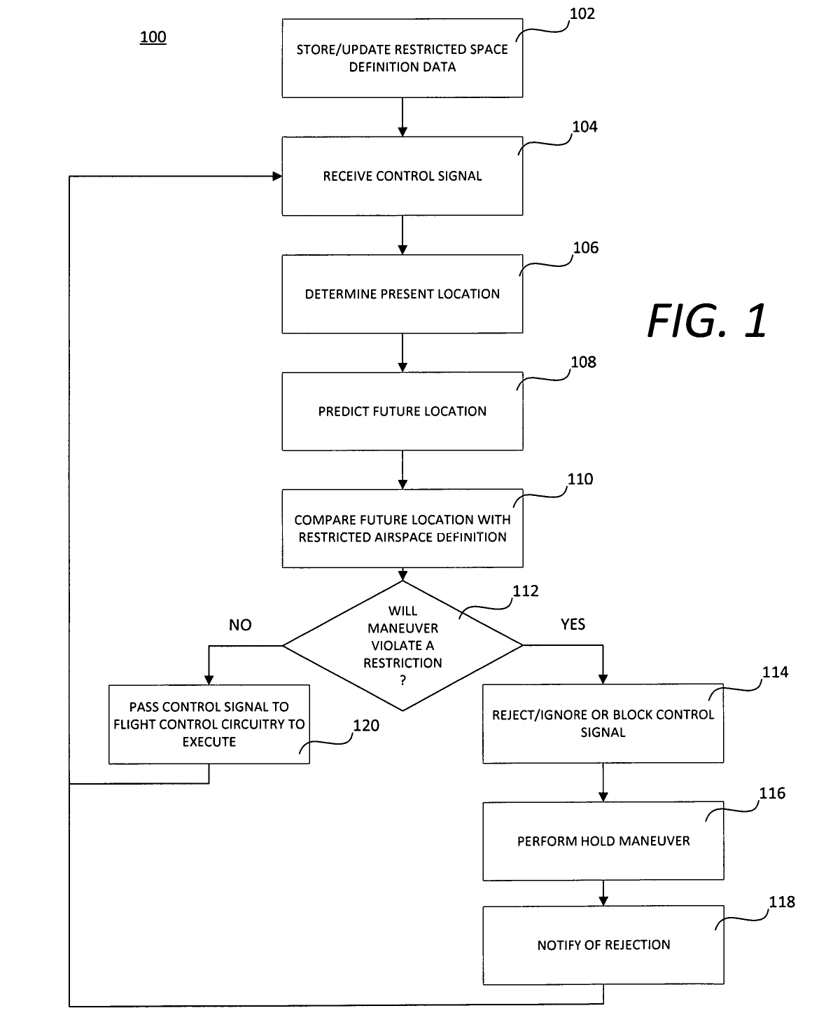

Referring to FIG. 1, a method 100 for controlling an unmanned aircraft according to an aspect of the present disclosure includes storing and/or updating a set of predetermined boundaries of restricted locations and/or storing a database of the restricted locations into a memory on board the unmanned aircraft at block 102. At block 104, the method includes receiving a control signal by the unmanned aircraft. The control signal may be a wireless control signal received in substantially real time or the control signal may be a preprogrammed control signal, for example. At block 106, the method includes determining a present location of the unmanned aircraft. The present location of the unmanned aircraft may be determined by GPS circuitry on the unmanned aircraft or by using any other location determining technique, such as radar or predictive algorithms, for example.

In one embodiment, the present location of the unmanned aircraft may comprise a simple altitude, for example, where a regulation prescribes a maximum altitude for operating the unmanned aircraft. The altitude may be determined by a GPS sensor on the aircraft, or by other altitude measuring sensors, such as an air pressure sensor, for example.

In another embodiment, the present location of the unmanned aircraft may be a relative to another position, such as the position of a person controlling the aircraft. For example, where regulations require an operator to maintain visual contact with the unmanned aircraft, the aircraft may include optical sensors, such as one or more dedicated digital cameras for example that are oriented toward the operator. Image recognition algorithms may be implemented in software on the aircraft and/or on the controller and configured to indicate whether the an image of the operator or an image of the controller is detectable by the optical sensors during flight. Reflectors, lasers, visible or ultraviolet light emitters may be positioned with the operator or mounted on a controller device, to aid the optical recognition of the operators or controller by the aircraft. When the unmanned aircraft begins to become occluded by an obstacle such that the user no longer has line of sight communication with the unmanned aircraft, the optical sensors would not be able to acquire an image of the user or controller and would cause a loss of sight signal to be sent to the controller, or to be communicate within control circuitry on the aircraft. In response to the loss of sight signal, the aircraft is automatically commanded, by a control algorithm operating on the aircraft and/or on the controller, to backtrack to its immediately previous location until the optical sensors again acquire an image of the controller.

At block 108, the method includes predicting a future location of the unmanned aircraft based on the control signal and the present location. At block 110, the method includes comparing the predicted future location with predetermined boundaries of restricted locations. At block 112, the method includes determining whether performing a maneuver responsive to the control signal would violate a regulation. For example, the method includes determining a maneuver responsive to the control signal would violate the regulation when the predicted future location is within the predetermined boundaries or corresponds to a location in a predetermined database of restricted locations. At block 114, the method includes rejecting, ignoring or blocking the control signal in response to determining that performing the maneuver responsive to the control signal would violate the regulation. At block 116, the method optionally includes performing a holding maneuver and/or a predetermined alternate maneuver response to rejecting or blocking the control signal. At block 118, the method optionally includes transmitting a notification of rejection in response to rejecting or blocking the control signal. At block 120 the method includes automatically executing a maneuver in response to the control signal in response to determining that the maneuver would not violate a regulation or restriction.

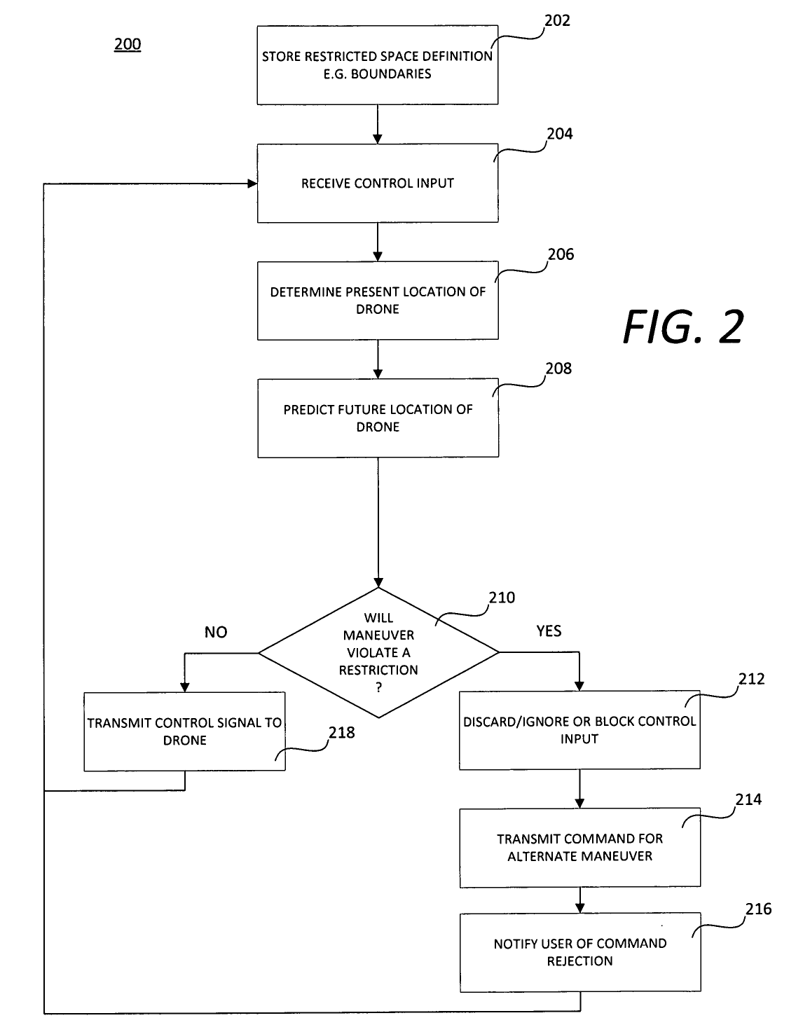

Referring to FIG. 2, a method 200 for controlling an unmanned aircraft according to an aspect of the present disclosure includes storing a database defining boundaries of restricted locations into a memory of the ground based remote control apparatus at block 202. At block 204, the method includes receiving a control input to a ground based remote control apparatus for controlling the unmanned aircraft. At block 206, the method includes determining a present location of the unmanned aircraft. At block 208, the method includes predicting a future location of the unmanned aircraft based on the control signal.

At block 210, the method includes determining whether performing a maneuver responsive to the control input by the unmanned aircraft would violate a regulation. For example, the method may include determining that performing the maneuver by the unmanned aircraft responsive the control input would violate a regulation when the predicted future location is within the boundaries of the restricted locations as defined in the stored database.

At block 212, the method includes automatically discarding, ignoring or blocking the control input without transmitting a control signal representing the control input in response to determining that performing the maneuver responsive to the control input would violate the regulation. At block 214, the method may optionally include transmitting a command to execute a predetermined alternate maneuver in response to rejecting, ignoring or blocking the control input. At block 216, the method may include signaling an alert condition to a pilot in response automatically discarding the control input.

At block 218, the method includes automatically transmitting a control signal representing the control input to the unmanned aircraft in response to determining that performing the maneuver responsive to the control input would not violate the regulation.

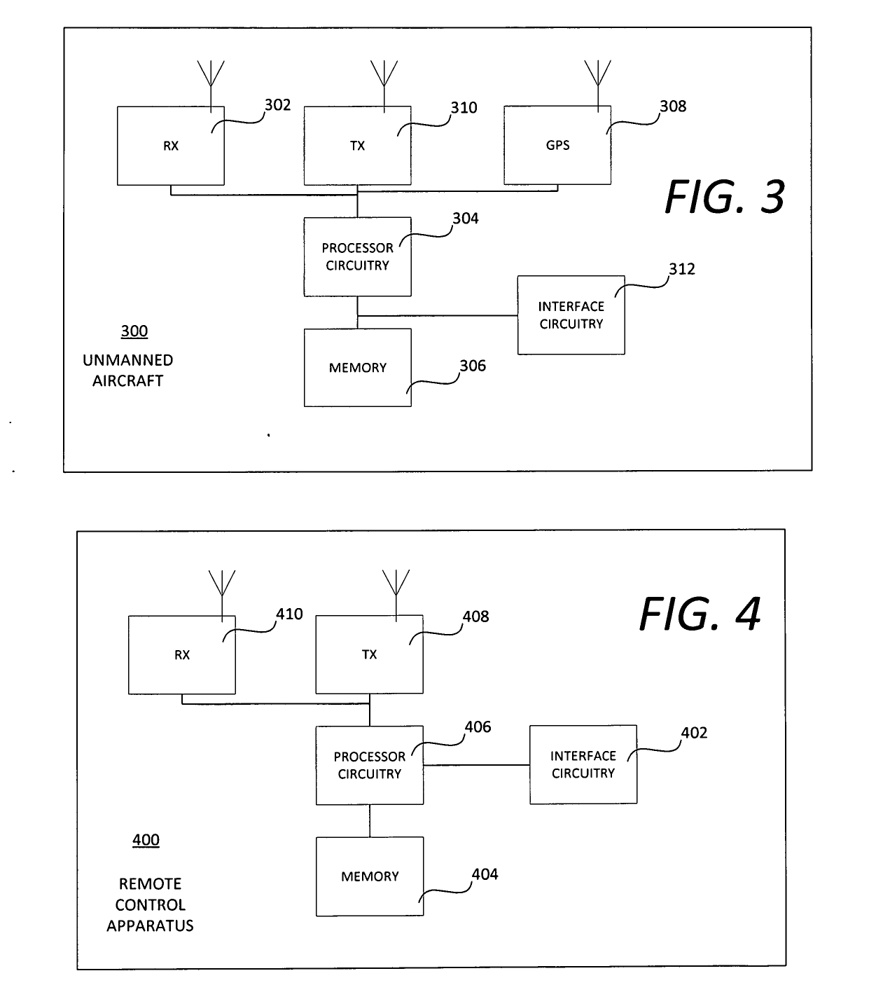

Referring to FIG. 3, an unmanned aircraft 300 according to an aspect of the present disclosure includes receiver circuitry 302 configured for receiving a control signal and processor circuitry 304 coupled to the receiver circuitry. The unmanned aircraft 300 also includes memory 306 coupled to the processor circuitry and storing a set of predetermined boundaries of restricted locations and/or storing a database of the restricted locations. Global positioning system (GPS) circuitry 308 is coupled to the processor circuitry and configured for determining the present location of the unmanned aircraft. Optionally, transmitter circuitry 310 and interface circuitry 312 may also be coupled to the processor circuitry.

According to aspects of the processor circuitry, the processor circuitry 304 is configured for determining whether performing a maneuver responsive to the control signal would violate a regulation or other predetermined constraint. The processor circuitry 304 is configured to predict a future location of the unmanned aircraft based on the control signal and the present location and then compare the predicted future location with predetermined boundaries of restricted locations. For example, the processor circuitry 304 determines that a maneuver responsive to the control signal would violate the regulation when the predicted future location is within the predetermined boundaries. According to aspects of the present disclosure, the processor circuitry 304 is configured to reject, block or ignore the control signal in response to determining that performing the maneuver responsive to the control signal would violate the regulation.

According to another aspect of the present disclosure, the memory 306 may also include stored control signals for performing a holding maneuver and/or a predetermined alternate maneuver in response to rejecting the control signal. The transmitter circuitry 310 may be configured for transmitting a notification of rejection in response to rejecting or ignoring the control signal. According to aspects of the present disclosure, the interface circuitry 312 is configured for loading and/or updating a database defining boundaries of restricted locations into the memory on board the unmanned aircraft; and

Referring to FIG. 4, a remote control apparatus 400 for controlling an unmanned aircraft according to aspects of the present disclosure includes a user interface 402 such as a joystick, keypad, touch screen, microphone, digital communication interface or the like, for receiving a control input for controlling the unmanned aircraft. According to an aspect of the present disclosure, the remote control apparatus 400 also includes a memory 404 configured for storing a database defining boundaries of restricted locations into a memory of the ground based remote control apparatus. Processor circuitry 406 is coupled to the memory 404 and to the user interface 402. Transmitter circuitry 408 is coupled to the processor circuitry.

The processor circuitry 406 is configured for determining whether performing a maneuver by the unmanned aircraft responsive to a control input to the user interface 402 would violate a regulation or other predetermined constraint. The processor circuitry 404 is configured for automatically discarding the control input without transmitting a control signal representing the control input in response to determining that performing the maneuver responsive to the control input would violate the regulation or other predetermined constraint. The processor circuitry is also configured for automatically transmitting a control signal representing the control input to the unmanned aircraft via the transmitter circuitry 408 in response to determining that performing the maneuver responsive to the control input would not violate the regulation or other predetermined constraint.

According to an aspect of the present disclosure, receiver circuitry 410 may also be coupled to the processor circuitry 406 and configured for receiving a present location report from the unmanned aircraft. According to this aspect of the present disclosure, the processor circuitry 406 is configured for predicting a future location of the unmanned aircraft based on the control signal and a reported present location of the unmanned aircraft. The processor circuitry 406 is configured to then compare the predicted future location with predetermined boundaries of restricted locations and determine that the maneuver responsive to the control signal would violate the regulation when the predicted future location is within the predetermined boundaries.

The term configured as used herein with respect to processor circuitry, receiver circuitry, transmitter circuitry or other circuitry and components may include arrangement of circuit elements, charging, discharging or setting certain voltage levels, or programming for example by coupling to a memory including executable program instructions.

Although aspects of the present disclosure are primarily directed to preventing encroachments of restricted airspace, other types of legal and regulatory restrictions may also be automatically enforced according to aspects of the present disclosure. For example, noise restrictions, speed restrictions, and proximity to other aircraft may be automatically enforced by ignoring, discarding and/or blocking commands that are received by the disclosed control system when the control system predicts that implementing the commands would violate the legal and/or regulatory restrictions as represented in memory. The term restricted airspace as used herein, may include any type of airspace limitation applicable to unmanned aircraft and is not limited to particular definitions with respect to the term “restricted” as used in the U.S. Federal Aviation Regulations for example. Moreover, it should be understood that the restrictions described herein may be defined by certain government agencies as laws or regulations, or may be user defined restrictions. For example, a user may add a restricted volume of airspace to the stored database of restricted airspace to avoid particular obstacles, such as a crane, for example. In another example, a user may store a user defined restricted airspace completely surrounding an intended course of travel to provide a tunnel through a buffer of airspace. In another example a restricted maneuvering space around a building or structure may be defined and stored in the memory so that an unmanned aircraft may be used to inspected for inspecting the building or structure without requiring precise operator control inputs.

In one example, the airspace database may be extracted or downloaded from a mapping service or other internet source. For example, a user may select a structure on a mapping source such as a Google Maps website. According to an aspect of the disclosure, a program or app may be provided to automatically generate, encode and/or electronically represent the desired boundaries and/or airspace definition for storage in the memory. The automatically generated air space definition may be based on a selected structure from the mapping source and a proximity limit defining an allowable proximity between the aircraft and the structure. The proximity limit may be predefined in the program/app or may be selectable by a user.

Embodiments of the disclosed control system may include an emergency override capability, in which the processor is configured to implement commands that are determined to violate restricted airspace, or other restricted flight parameters, only when an emergency override command is received. In one embodiment the controller and/or aircraft circuitry is configured to automatically notify local police, an air traffic control entity or other government agency such as the Federal Aviation Administration, when an emergency override signal is sent to an unmanned aircraft.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises,” “comprising,” “having,” “having,” “includes,” “including” and/or variations thereof, when used in this specification, specify the presence of stated features, steps, operations, elements, and/or components, but do not preclude the presence or addition of one or more other features, steps, operations, elements, components, and/or groups thereof.

It will be understood that when an element is referred to as being “connected” or “coupled” to another element (or variations thereof), it can be directly connected or coupled to the other element or intervening elements may be present. In contrast, when an element is referred to as being “directly connected” or “directly coupled” to another element (or variations thereof), there are no intervening elements present.

It will be understood that, although the terms first, second, etc. may be used herein to describe various elements and/or components, these elements and/or components should not be limited by these terms. These terms are only used to distinguish one element and/or component from another element and/or component. Thus, a first element or component discussed below could be termed a second element or component without departing from the teachings of the present disclosure.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Although the present disclosure has been described in connection with the embodiments of the present disclosure illustrated in the accompanying drawings, it is not limited thereto. Persons with skill in the art will recognize that embodiments of the present disclosure may be applied to other types of memory devices. The above-disclosed subject matter is to be considered illustrative, and not restrictive, and the appended claims are intended to cover all such modifications, enhancements, and other embodiments, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

It will further be appreciated by those of skill in the art that the execution of the various machine-implemented processes and steps described herein may occur via the computerized execution of computer-executable instructions stored on a tangible computer-readable medium, e.g., RAM, ROM, PROM, volatile, nonvolatile, or other electronic memory mechanism.

Thus, it will be appreciated that a new and useful method and system for controlling an unmanned aircraft has been described herein. However, it will also be appreciated that the disclosed embodiments are merely examples, and that the described principles are more widely applicable, Aft references, including publications, patent applications, and patents, cited herein are hereby incorporated by reference to the same extent as if each reference were individually and specifically indicated to be incorporated by reference and were set forth in its entirety herein.

The use of the teens “a” and “an” and “the” and similar referents in the context of describing the disclosure (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend fir the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

For a firmware and/or software implementation, the methodologies may be implemented with modules (e.g., procedures, functions, and so on) that perform the functions described herein. A machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to types of long term, short term, volatile, nonvolatile, or other memory and is not to be limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular configurations of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

What is claimed is:

1. A method for controlling an unmanned aircraft, comprising:
receiving a control signal;
determining whether performing a maneuver responsive to the control signal would violate a regulation; and
rejecting or ignoring the control signal in response to determining that performing the maneuver responsive to the control signal would violate the regulation.

2. The method of claim 1, further comprising:
performing a holding maneuver and/or a predetermined alternate maneuver response to rejecting the control signal.

3. The method of claim 1, further comprising:
predicting a future location of the unmanned aircraft based on the control signal;
comparing the future location with predetermined boundaries of restricted locations;
determining that the maneuver responsive to the control signal would violate the regulation when the predicted future location is within the predetermined boundaries.

4. The method of claim 1, further comprising:
predicting a future location of the unmanned aircraft based on the control signal;
comparing the future location with a predetermined database of restricted locations;
determining that the maneuver responsive to the control signal would violate the regulation when the predicted future location corresponds to a location in the predetermined database of restricted locations.

5. The method of claim 1, further comprising:
storing a set of predetermined boundaries of restricted locations and/or storing a database of the restricted locations.

6. The method of claim 1, further comprising:
loading a database defining boundaries of restricted locations into a memory on board the unmanned aircraft; and
rejecting the command after receiving the command by the unmanned aircraft.

7. The method of claim 1, in which the control signal is a wireless control signal received in substantially real time.

8. The method of claim 1, in which the control signal is a preprogrammed control signal.

9. A method for controlling an unmanned aircraft, comprising:
receiving a control input to a ground based remote control apparatus for controlling the unmanned aircraft;
storing a database defining boundaries of restricted locations into a memory of the ground based remote control apparatus;
determining whether performing a maneuver responsive to the control input by the unmanned aircraft would violate a regulation;
automatically discarding the control input without transmitting a control signal representing the control input in response to determining that performing the maneuver responsive to the control input would violate the regulation; and
automatically transmitting a control signal representing the control input to the unmanned aircraft in response to determining that performing the maneuver responsive to the control input would not violate the regulation.

10. The method of claim 9, comprising:
determining a present location of the unmanned aircraft; and
predicting a future location of the unmanned aircraft based on the control signal;
determining whether performing the maneuver by the unmanned aircraft responsive the control input would violate a regulation when the predicted future location is within the boundaries of the restricted locations as defined in the stored database.

11. The method of claim 9, further comprising:
transmitting a command to execute a predetermined alternate maneuver in response to rejecting the command.

12. The method of claim 9, further comprising:
signaling an alert condition to a pilot in response automatically discarding the control input.

13. An unmanned aircraft, comprising:
receiver circuitry for receiving a control signal;
memory storing a set of predetermined boundaries of restricted locations and/or storing a database of the restricted locations;
processor circuitry coupled to the receiver circuitry and to the memory, the processor circuitry configured for determining whether performing a maneuver responsive to the control signal would violate a regulation; and
the processor circuitry configured for rejecting or ignoring the control signal in response to determining that performing the maneuver responsive to the control signal would violate the regulation.

14. The unmanned aircraft of claim 13, comprising:
the processor circuitry configured for predicting a future location of the unmanned aircraft based on the control signal;
the processor circuitry configured for comparing the future location with predetermined boundaries of restricted locations; and
the processor circuitry configured for determining that the maneuver responsive to the control signal would violate the regulation when the predicted future location is within the predetermined boundaries.

15. The unmanned aircraft of claim 14, comprising:
global positioning system circuitry configured for determining the present location of the unmanned aircraft;
the processor circuitry configured for predicting the future location of the unmanned aircraft based on the control signal and based on the present location.

16. The unmanned aircraft of claim 13, comprising:
the processor configured for predicting a future location of the unmanned aircraft based on the control signal;
the processor configured for comparing the future location with a predetermined database of restricted locations;
the processor configured for determining that the maneuver responsive to the control signal would violate the regulation when the predicted future location corresponds to a location in the predetermined database of restricted locations.

17. The unmanned aircraft of claim 13, comprising:
interface circuitry configured for loading a database defining boundaries of restricted locations into the memory on board the unmanned aircraft; and
rejecting the command after receiving the command by the unmanned aircraft.

18. The unmanned aircraft of claim 13, in which the control signal is a wireless control signal received in substantially real time.

19. The unmanned aircraft of claim 13, in which the control signal is a preprogrammed control signal stored in the memory.

20. The unmanned aircraft of claim 13, in which the memory includes stored control signals for performing a holding maneuver and/or a predetermined alternate maneuver response to rejecting the control signal.

21. A remote control apparatus for controlling an unmanned aircraft, the remote control apparatus comprising:
a user interface for receiving a control input to the remote control apparatus for controlling the unmanned aircraft;
memory configured for storing a database defining boundaries of restricted locations into a memory of the ground based remote control apparatus;
processor circuitry coupled to the memory and to the user interface, the processor circuitry configured for determining whether performing a maneuver responsive to the control input by the unmanned aircraft would violate a regulation;
the processor circuitry configured for automatically discarding the control input without transmitting a control signal representing the control input in response to determining that performing the maneuver responsive to the control input would violate the regulation; and
transmitter circuitry coupled to the processor circuitry, the processor circuitry configured for automatically transmitting a control signal representing the control input to the unmanned aircraft via the transmitter circuitry in response to determining that performing the maneuver responsive to the control input would not violate the regulation.

22. The remote control apparatus of claim 21, comprising:
the processor circuitry configured for predicting a future location of the unmanned aircraft based on the control signal;
the processor circuitry configured for comparing the future location with predetermined boundaries of restricted locations; and
the processor circuitry configured for determining that the maneuver responsive to the control signal would violate the regulation when the predicted future location is within the predetermined boundaries.

23. The remote control apparatus of claim 21, comprising:
receiver circuitry configured for receiving a present location report from the unmanned aircraft;
the processor circuitry configured for predicting the future location of the unmanned aircraft based on the control signal and based on the present location report.
